(19) United States
(12) Patent Application Publication
(10) Pub. No.: US 2026/0311554 A1
(43) Pub. Date: Oct. 8, 2026

(54) SYSTEM AND METHOD FOR ANALYZING TABLE GAME PLAY WITH DELAYED ALERTING OF DETECTED ADVANTAGE GAME PLAY

(71) Applicant: Tavolo Intellect LLC, Grosse Pointe, MI (US)

(72) Inventor: Ryan Patrick McClellan, Grosse Pointe, MI (US)

(21) Appl. No.: 19/640,649

(22) Filed: Apr. 7, 2026

Related U.S. Application Data
(60) Provisional application No. 63/785,156, filed on Apr. 8, 2025.

(51) Int. Cl. G07F 17/32; G06V 10/25; G06V 20/52

(52) U.S. Cl. CPC G07F 17/3241; G06V 10/25; G06V 20/52; G07F 17/3237

(57) ABSTRACT

A method for monitoring gameplay at a casino gaming table that includes: receiving, by one or more processors, data associated with the casino gaming table from one or more detection devices; processing the data to generate gameplay event data; detecting a first trigger event corresponding to initiation of a gameplay session; tracking gameplay activity at the casino gaming table using the gameplay event data; detecting, a second trigger event corresponding to completion of the gameplay session; analyzing the gameplay event data to identify a pattern of player behavior indicative of advantage play; generating an alert record based on the identified pattern; and at least temporarily storing the alert record in a memory until after the second trigger event is detected before transmitting the alert record.

### CROSS-REFERENCE TO RELATED APPLICATIONS

This application claims priority to US 63/785,156 filed on Apr. 08, 2025, the entirety of which is hereby incorporated by reference herein for all purposes.

### FIELD

These teachings relate to a system and method of analyzing casino table game play with delayed alerting of detected advantage game play.

### BACKGROUND

It is well known that many casino table games are designed with a built-in mathematical advantage favoring the house. One way that players attempt to gain an advantage over the house or casino is to utilize a strategy called card counting. During game play, card counters keep a mental running tally or count of high and low-value cards that have been dealt. Based on the running count of the high and low-value cards, card counters use statistics to predict if the next dealt hand will give an advantage to the player or to the dealer and then adjust their bet and playing strategy accordingly.

Another way players attempt to gain an advance over the house or casino is to use a strategy known as hole carding. Hole carding involves a team of players who work to observe a dealer’s hole card (the facedown card) while it is still hidden from the players and then use this information to adjust betting and decision-making.

When a casino identifies potential advantage play, for example by a card counter or hole carding team during game play, or determines that the house advantage has shifted in favor of the player, the casino or dealer may wish to take corrective action or otherwise interfere with the game, for example by shuffling the cards to reduce or remove the player advantage. However, to ensure an even playing field for players, many casino gaming commissions or jurisdictions restrict a casino or dealer from interfering with a game that is in progress, such as by shuffling the cards, until completion of a hand or gameplay session.

To help identify advantage play, solutions have been previously proposed to monitor or analyze game play at casino table games using human surveillance. However, such solutions are often labor intensive, subject to human error, and may be inconsistent in detecting patterns of player behavior over time.

It may therefore be desirable to improve the current state of the art by providing a system and/or method for analyzing game play at a casino. In some situations, to comply with casino gaming regulations, if the system and/or method detects or identifies suspicious player betting or playing behavior during game play, it may be desirable to delay alerting or communication of such behavior to casino personnel until after completion of the game play at the casino gaming table.

### SUMMARY

These teachings provide a system and method for monitoring and/or analyzing game play at a casino, including processing image data associated with or representing game plate at one or more gaming tables to identify gameplay events and evaluate player behavior.

The system and method may utilize one or more detection devices. The one or more detection devices may be configured to obtain still images, video images, of one or more regions of interest on the gaming table and/or representative of game play at the gaming table. The one or more detection devices may generate image data representing one or more gaming elements, including the presence or absence of items on the gaming table.

For example, the detection devices may capture image data associated with gaming cards dealt from a deck or shoe, card suit and value, wager amounts (e.g., currency and/or gaming chips), a number of cards dealt or remaining, and player or dealer activity at the gaming table. The one or more detection devices may be configured to obtain or generate video and/or still images of one or more players that are playing at the game, the dealer, or any combination thereof.

The generated video and/or still images and/or sensor data may be provided or communicated to one or more computing devices. A computing device may include data processing hardware, memory, software, rules, processors, and/or structure for assessing or interpreting the video and/or still images from the one or more detection devices, and correlating the video and/or still images to what is/was observed.

The one or more computing devices may correlate or determine the suit and/or value of the cards dealt, the value of any bets made by the one or more players (e.g., currently and/or gaming chips), the number of cards that have been dealt, the number of cards remaining in the shoe, the bet and play strategy of one or more players, or a combination thereof. In some configurations, the one or more computing devices may estimate the number of cards that have been dealt and/or the number of cards left in the card shoe.

To process, assess, interpret, or correlate the one or more still images/video and/or sensor data, a computing device may have or use one or more models representing the playing cards and/or gaming chips and games rules to understand the images and/or video feed and/or sensor data that is provided by the one or more detecting devices. The computing devices may match the video and/or still images and/or sensor data to one or more models to understand or determine the suit and value of the cards dealt, the value of any bets made by the one or more players (e.g., currently and/or gaming chips), the number of cards that have been dealt, the number of cards remaining in the shoe, etc.

The computing device may be configured to apply a time stamp to the one or more video and/or still images and/or sensor data. The computing device may be configured to correlate the one or more video or still images and/or sensor data to one or more player identities based on a known player profile (e.g., such as linked to a player loyalty or rating system) or to an unknown profile using facial recognition or another method of assigning play to an unknown player. The computing device may output its information or data to one or more analysis devices.

An analysis device may function to or be configured to consider, interpret, analyze and/or apply the video and/or images and/or sensor data from the detection device or the computing device to one or more algorithms, software, rules, basic strategy, machine learning, deep learning, statistics, mathematical formula, data processing hardware, memory, processor, computing devices, and/or lookup tables of the analysis device to assess game play and/or one or more player’s behavior during game play.

The analysis device may be configured to input or apply the one or more video and/or still images and/or sensor data into the one or more algorithms, software, rules, basic strategy, machine learning, deep learning, statistics, and/or lookup tables to predict the next hand that will be dealt by the dealer, and whether the hand will be in the player’s favor or advantage or in the dealer’s favor or advantage. For example, considering the previously dealt cards and/or suits/values of cards that have not yet been dealt, the analysis device may apply one or more algorithms, software, rules, basic strategy, machine learning, deep learning, statistics, mathematical formula, and/or lookup tables to predict the value and/or suits of cards that will be dealt next by the dealer (e.g., in the very next hand and/or in later hands).

The analysis device and/or computing device may be configured to evaluate how a player is betting and whether the betting is consistent with the predicted next hand(s) that will be dealt. For example, if the analysis device determines that the player is manipulating its bets based on a predicted or actual change in advantage (e.g., player increasing bet amounts when the prediction is the advantage is in the player’s favor and/or decreasing bet amounts when the prediction is the advantage is in the house or casino’s favor), the analysis device may conclude that the player is utilizing card counting techniques, hole carding, or other advantage play. On the other hand, if the player’s bet and play strategy does not appear to be following predicted or actual changes in advantage, then the analysis device may conclude that the player is simply lucky, unlucky, or playing according to player ability.

To make such an assessment, the analysis device may take into consideration the amount of time or the duration that the player is at the table playing the game. The longer that the player is at the table, the better the confidence level of the output from the analysis device. The analysis device may have a clock or elapsed time of observation or number of hands that must be met or surpassed, before the analysis device may make its output or determination of advantage play.

Accordingly, the analysis device or the one or more processors may analysis the gameplay event data to identify one or more patterns of player behavior indicative of advantage play, anomalous behavior, or predefined behavioral conditions.

In some configurations, the analysis device and/or the computing device may store or record game play for future evaluation. This may be advantageous for the analysis device to track one or more players over time. For example, if the player moves from one table to another, from one casino location to another, or returns to a casino at a later time, the analysis device may consider the previous game play in its analysis whether the player is utilizing advantage play or if the player is part of a hole card team. This may further lead to a higher or greater confidence level for the device. The data may be stored as an image, video, log file or facial recognition profile.

In an embodiment, the analysis device, based on video/still images and/or sensor data received from the one or more detection devices, and/or data from the one or more computing devices, may be configured to detect or determine if a player makes their first wager when the analysis device determines that the count is in the player’s favor and continues to wager while the count is in the player’s favor. If the player stops betting, reduces their bet amount, or departs from the table after the predicted count changes to the casino’s favor, the analysis device may classify the player as a potential card counter. The analysis device may then be configured to update a player profile associated with the player as a potential card counter. In the event the player does this at multiple tables, the casino may ask the player to leave, adjust the maximum betting limits at tables the player is in proximity to, adjust the maximum on all similar games, or add no-mid shoe entry verbiage to any or all similar games, with the intention of limiting the player’s betting.

In an embodiment, if a potential card counter is detected or perceived by the system and/or method disclosed herein, the analysis device, the computing device, and/or the alerting device may be configured to adjust betting limits at the gaming table. For example, if the system and/or method disclosed herein determines, within a certain degree of confidence, that the player is a card counter, then the system and/or method disclosed herein may automatically update maximum betting limit amount at the table. In such a configuration, the system, method, analysis device, computing device, and/or alerting device may be in electronic communication (wired and/or wireless communication protocol) with a table sign to make such an update. In such a configuration a visual notification on a keypad and/or an audible notification device, such as a speaker, may alert the dealer of such a change to a rule and/or limit change at the table. In an embodiment, the system, method, analysis device, computing device, and/or alerting device may provide a recommendation to casino staff (e.g., pit boss, dealer, etc.) to change the bet limits at the table if a card counter is detected or perceived within a certain degree of confidence. The casino staff may then take action to update the bet limits if they believe it is necessary to protect the casino and/or to disincentivize the player from continuing to play. The automatic adjustment of the betting limits at the gaming table or the recommendation to reduce the betting limit may be an alert that is provided or output from the one or more alerting devices disclosed herein.

In an embodiment, if the analysis device identifies a player entering game play mid round (e.g., in the middle of a card shoe), and the player is making higher betting wagers when the count is in the player’s advantage, then the system, method, analysis device, computing device, and/or alerting device may automatically update the table limit sign to include a rule “no mid-shoe entry” or “mid-shoe entry $100 max” or similar bet restricting verbiage. This may prohibit that player or future players from entering game play while the dealer is dealing from the shoe or limit their wager should they enter the game mid-shoe. This may prohibit or inhibit an advantage player from entering the game. The player must then wait until the session is over (e.g., cards have been entirely dealt from the card shoe) and the advantage is reset, before the player can enter. This game rule change may be applicable to only one table, or to two or more tables in the area or the casino to prevent the player from entering a game at another gaming table.

In an embodiment, the system and/or method disclosed herein, may be configured to detect or identify a hole card team that may be engaged in card counting. A hole card team works by leveraging the strategy of gaining an unfair advantage over the casino through the observation of the dealer's hole card (the facedown card) while it is still hidden from the players. The idea behind this strategy is to have one or more team members look at the dealer's hole card without detection, and then use this information to inform betting and decision-making. Such a team may comprise a spotter, who focus on observing the dealer’s hole card by being positioned at a certain angle or use specific movements to view the dealer’s hole card without the dealer noticing. A spotter typically does not place large bets. The team may comprise a player who places bets acting on information from the spotter. The team may comprise a big player that is brought in when a spotter sees a favorable hole card and places large bets. The team may comprise a back-off player if the team is spotted or the casino becomes suspicious of the team operating in the casino. The back-off player is used to distract or take attention away from the team.

For example, if two or more of the players at the table are playing far from basic strategy, and one or more of the players are wagering a significant sum, a potential hole card team may be operating. If the player with the large sum is making decisions that differ from that of basic strategy, the analysis and/or alerting device may issue an alert. For instance, if the dealer has an up 6, and the player with the high wager has a 12, and they hit, the system will log this. If the dealer flips their hole card and it’s a 5 an alert or alert record would be sent. A player would stand on an up 6 because it’s assumed a 10 is underneath. If the 5 was exposed they would know this and make decisions to play the best odds against the dealer’s known hand.

The analysis device may be configured to output its determination, evaluation, or analysis via an output to one or more alerting devices or external devices. The external device or alerting device may provide the alert or alert record to interested casino surveillance or staff via an audible and/or visual communication to one or more personal, which may include casino surveillance, a dealer, a pit boss, or a combination thereof. The output may be a notation or alert placed in a player profile, tracking, or ranking system. Such information may be used to build a player’s profile for rewards or reinvestment purposes. In other configurations, the information may be used to track the individual as a potential card counter or skilled player and can put other casinos, tables, and/or dealers on notice of the player’s ability. By building this profile, a casino may be able to track a player over time to better ensure the conclusion of card counting, hole carding, or other advantage play has a higher degree of confidence before the casino takes certain action (such as banning a person from future game play). This may help prevent a situation where the analysis device provides a false positive. Additionally, the building of the profile with their bet and play strategy may help a casino track any further suspicious behavior or routines, such as a player repeatedly visiting a specific table and/or dealer.

In some configurations, the alert or alert record or output signal may be a rule change. For example, the alerting device may be configured to automatically update a casino limit sign to change maximum betting amounts if a card counter is detected. This may limit the casino’s exposure from a player taking advantage when the counter is in the player’s favor. In other configurations, the alerting device may be configured to notify casino staff with a recommendation to change maximum betting amounts, or the maximum amount a player may wager if they enter the game mid-shoe, if a card counter is detected. The alert or alert record may be provided to the casino staff via a back side of the table limit sign or via another alerting device such as a keypad or tablet. The casino staff would be required to take an action to accept the recommendation before the bet limit is changed.

In an embodiment, the output from the analysis device is preferably not shared with casino staff, surveillance, or other personnel during actual game play. The alert record or output signal is stored in a memory structure and prevented from being accessed by or sent to or transmitted to one or more external devices prior to detection of the second trigger. Instead, the output may be provided from the analysis device only after a game play session has ended and/or after a predetermined time interval after a game play session has been determined to have ended in order to build in an additional safety buffer. A session may be defined as a period between the start of dealing of a gaming shoe until it’s completion. The end of the gaming or dealing shoe may be defined or determined when or after one or more detection devices or sensor devices or computing device identifies presence of a cut card and/or the cards being removed from the discard rack triggering a shuffle event. The end of the gaming or dealing shoe may be defined or determined when or after a predetermined number of cards or decks have been dealt, which may be counted or estimated by the computing device. The end of the session may be determined by gaming chips being collected and/or gaming chips being paid out by the dealer to a player. The end of the session may be determined by the occurrence of one or more trigger events disclosed herein. An output or determination may be delayed and locked or contained in the analysis device or in the alert device until after the game or session has ended.

In some embodiments, the alert may be delayed or prevented from being transferred to an external device or to casino personnel to avoid interference with ongoing gameplay and to ensure compliance with applicable gaming commission or jurisdictional rules. For example, because certain forms of advantage play (e.g., card counting) are not inherently illegal, premature notification to casino operators or dealers could prompt immediate intervention—such as shuffling the deck or restarting a session—to gain an advantage over the player, which may be prohibited or restricted by casino regulations. By delaying transmission of the alert until a suitable condition is met (e.g., completion of a hand, shoe, or gaming session), the system enables continued, uninterrupted observation of gameplay, preserves the natural progression of the game, and maintains the integrity of the collected data. This approach further allows casino personnel to take measured, policy-compliant actions at an appropriate time, thereby improving operational consistency and the evidentiary value of detected gameplay patterns.

After game play has ended, the analysis device or computing device may output the alert or determination to one or more devices, external devise, and/or casino personnel for possible further action by the casino. Because the alert or determination of suspicious behavior is delayed or not output from the analysis device until a trigger event has been observed that is commensurate with the end of game play, the player may continue to play without risk of the casino or dealer interfering, which may not be allowed by gaming jurisdictions.

Information and/or data from the one or more detection devices and/or the computing device may be provided to the analysis device in real time while game play is taking place. The analysis device may review the information or data in real time and apply the information or data to the one or more algorithms, machine learning, deep learning, and/or software in real time. However, the alert notice is held or prevented from being communicated to an external device or casino operators until after the trigger is received, indicative of an end of game play.

In other configurations, the information and/or data from the one or more detection devices and/or the computing device may be held in a memory structure, queue, or buffer and provided to the analysis device only after a trigger event has been identified or determined by the detection device or computing device that is indicative of the game play our session being over. Until the game is over, the one or more images or video feed may be stored in a temporary database or processor until the information or data is sent to and/or processed to the analysis device.

In other configurations, the detection device may send or provide information to the analysis device after a trigger event has been detected that is indicative of an end of a session. The analysis device may then review game play over the last session and apply it to game rules, basic strategy, and machine learning or deep learning analytics to make a determination, with a certain degree of confidence, if the player bet and paying strategy was influenced by card counting, hole carding, ace sequencing, team spreading, shuffle tracking, or other advantage play. The alert or alert record may be provided to casino surveillance or a dealer before the next session of game play begins so that appropriate action can be taken. Because the alert or alert record or determination of suspicious behavior is not output from the analysis device until a trigger event has been observed that is commensurate with the end of game play, the player may continue to play without risk of the casino or dealer interfering and be in compliance with casino gaming commissions or jurisdiction rules.

The one or more detection devices, computing devices, analysis devices, and/or alerting devices may be contained within a single unit. The one or more detection devices, computing devices, analysis devices, and/or alerting devices may be two or more separate units that are connected via one or more wired or wireless communication protocols. The one or more detection devices, computing devices, analysis devices, and/or alerting devices may be configured to monitor or observe a single gaming table, or may be configured to monitor or observe multiple gaming tables. The hardware of the one or more detection devices, computing devices, analysis devices, and/or alerting devices may be located at each of the casino gaming tables. The one or more detection devices, computing devices, analysis devices, and/or alerting devices may be located away from the casino gaming tables. For example, the one or more devices may be located at a secure location of the casino and/or in the cloud.

In some configurations, an image or computing feed from one or more detecting devices and/or computing devices may be provided to a central analysis device. In other words, the casino may have one or more analysis devices that is configured to analyze game play of multiple players and/or gaming tables. In some configurations, the one or more computing devices, analysis devices, and/or alerting devices may be located in the cloud or offsite from the premise or casino.

A computer-implemented method for monitoring gameplay at a casino gaming table is disclsoed herein. The one or more method steps include: receiving, by one or more processors, data representing gameplay at the casino gaming table from one or more detection devices the data comprising at least one of image data or sensor data; processing, by the one or more processors, the data to generate gameplay event data; detecting, by the one or more processors and from the gameplay event data, a first trigger event corresponding to initiation of a gameplay session; in response to detecting the first trigger event, tracking gameplay activity at the casino gaming table using the gameplay event data; detecting, by the one or more processors and from the gameplay event data, a second trigger event corresponding to completion of the gameplay session; analyzing, by the one or more processors, the gameplay event data to identify one or more patterns of player behavior indicative of advantage play, anomalous behavior, or predefined behavioral conditions; generating, by the one or more processors, an alert, alert record, or output signal based on the identified one or more patterns of behavior and at least temporarily storing the alert record in a memory structure and preventing access to, activation of, or transmission of the alert or alert record or the output signal to one or more external devices prior to detection of the second trigger; and in response to detection of the second trigger event, enabling transmission or activation of the alert, alert record, or output signal to one or more external devices.

A system for monitoring gameplay at a casino gaming table is disclsoed. The system comprises one or more detection devices configured to capture data associated with the casino gaming table; one or more processors in communication with the one or more detection devices; and a memory in communication with the one or more processors, the memory storing instructions that, when executed by the one or more processors, cause the one or more processors to: receive the data from the one or more detection devices; process the data to generate gameplay event data; detect, from the gameplay event data, a first trigger event corresponding to initiation of a gameplay session; track gameplay activity based on the gameplay event data; detect, from the gameplay event data, a second trigger event corresponding to completion of the gameplay session; analyze the gameplay event data to identify one or more patterns of player behavior indicative of advantage play, anomalous behavior, or predefined behavioral conditions; generate an alert record or output signal based on the identified pattern; store the alert record in a memory structure and preventing access to, activation of, or transmission of the alert record or the output signal to one or more external devices prior to detection of the second trigger; and transmit the alert record to an external device in response to detection of the second trigger event.

### BRIEF DESCRIPTION OF THE DRAWINGS

FIG. 1 is a perspective view of an exemplary casino gaming table configured for use with the systems and methods described herein.

FIG. 2 is a flow chart illustrating the system and method disclosed herein.

### DETAILED DESCRIPTION

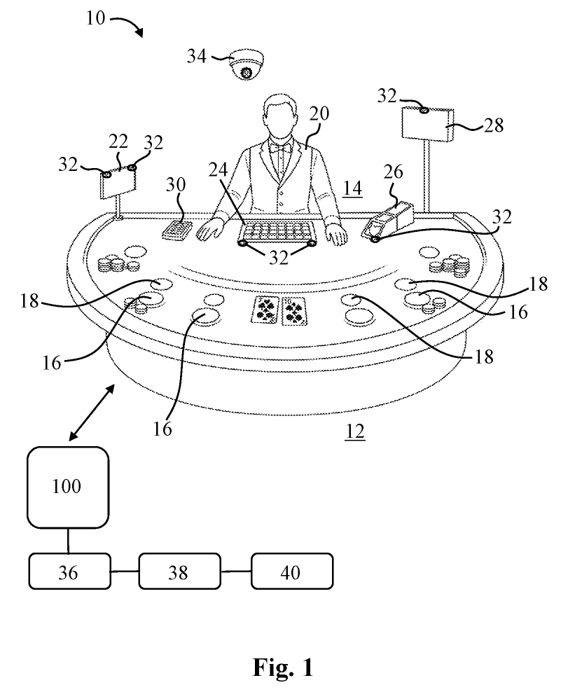

FIG. 1 illustrates a gaming table 10. The gaming table 10 may be found or located in a casino, hotel, cruise ship, or other facility or venue. One or more casino games, including blackjack, roulette, baccarat, craps, pai gow, or the like, may be played at the gaming table 10.

Generally, the gaming table 10 comprises a player area 12 and a dealer area 14. The player area 12 includes one or more betting regions 16 and, optionally, one or more side wager regions 18 at which one or more players may place wagers during gameplay. The dealer area 14 is configured to accommodate a casino dealer 20 and/or other casino staff during gameplay.

The gaming table 10 may include one or more table signs 22, a chip tray 24 configured to store gaming chips, a card shoe 26 configured to hold playing cards, one or more elevated table or tower signs 28, and/or one or more key pads 30.

One or more regions of interest may be defined at the gaming table 10. The one or more regions of interest may be at the player area 12, the dealer area 14, or both.

A region of interest may be an area or region of the gaming table 10 where one or more players and the dealer interact during game play. For example, a region of interest may be or may include one or more of the betting regions 16, side wager regions 18, the chip tray 24, the card shoe 26, a card discard tray or rack, the dealer area 14 where the dealer may deal and/or show cards, the player area 12 where the one or more cards are dealt to the players or where a player places bets, or any combination thereof. The one or more regions of interest may be monitored by one or more detection devices 32, 34.

One or more detection devices 32 may be configured to or used for observing the gaming table and/or game play at the gaming table 10. The one or more detection devices 32 may include one or more cameras and/or sensors. A detection device 32 may be added to, provided on, or incorporated into one or more elements of the gaming table 10, such as the table 10 itself, one or more table signs 22, chip tray 24, card shoe 26, elevated table or tower signs 28, discard rack, keypad 30, etc. The one or more detection devices may generate data (e.g., image data, sensor data, etc.) that is processed to extract features corresponding to gaming objects, player actions, and gameplay events.

The gaming facility or venue (e.g., the casino building) where the gaming table 10 is located may include one or more detection devices 34, which may be part of the casino surveillance system. The one or more detection devices 32, 34 may be one or more cameras and/or sensors. Personnel responsible for the integrity of the gaming or gambling at the casino and/or casino security and surveillance for monitoring casino game play typically has access to these surveillance detection devices 34. A surveillance detection device 34 may be elevated or located above a gaming table 10 and attached to a wall or ceiling of the facility. The surveillance detection device 34 may be located directly overhead of the gaming table 10 and/or at located overhead but at an angle relative to the gaming table.

One or more of the detection devices 32,34 may be one or more cameras having PTZ capabilities (Pan/Tilt/Zoom) or a fixed, non PTZ camera, or a combination thereof. The one or more detection devices 32,34 may be configured to monitor, detect, identify, observe, and/or record one or more elements of the gaming table and/or elements used with the gaming table for casino game play, such as, for example: playing cards, gaming chips, card shufflers, discard racks, cut cards, currency, dice, dice values, betting regions, etc. The one or more detection devices 32,34 may be configured to monitor, detect, identify, observe, and/or record movements or physical characteristics made by casino staff (e.g., dealer, pit boss, etc.), casino patrons or players, observers, or a combination thereof. For example, the one or more detection devices 32,34 may be configured to monitor, detect, identify, observe, and/or record facial recognition of a dealer or player and/or movements of a dealer dealing cards, performing currency buy-in or cash out, a player making various hand signals (hold, hit, etc.), a player leaving a gaming table, a player approaching a gaming table, etc. The one or more detection devices 32,34 may be configured to monitor or observe playing card values and suits (ace, 2, 4, 6, king, queen, spade, heart, diamond, etc.), values of one or more gaming chips, value of currency, or a combination thereof.

One or more of the detection devices 32, 34 may be one or more sensors such as RFID sensors, presence sensors, proximity sensors, or any combination thereof. In some embodiments, the one or more detection devices may include optical sensors (e.g., cameras, infrared sensors, depth sensors), weight sensors, pressure sensors, capacitive sensors, motion sensors, ultra-wideband sensors, RFID readers, NFC readers, or combinations thereof.

In some configurations, one or more optical sensors 32, 34 may be positioned to capture image or video data associated with gameplay, including player actions, card distributions, chip movements, and dealer interactions. Additionally, or alternatively, one or more RFID or NFC readers may be configured to detect and identify tagged gaming elements, such as chips, cards, or other objects used during gameplay.

The one or more detection devices 32,34 may output one or more data, signals, still images and/or video feed(s) to one or more computing devices 30. The one or more detection devices 32,34 may be in electronic communication (e.g., wired or wireless) with and/or may be part of one or more computing devices 36.

In response to receiving the one or more data, signals, images and/or camera feed from the one or more detection devices 32,34 the one or more computing devices 36 may be configured to determine the actual playing card values and suits (ace, 2, 4, 6, king, queen, spade, heart, diamond, etc.), values of one or more gaming chips, value of currency, or a combination thereof. The computing device may execute one or more image processing operations including object detection, classification, and tracking to convert the data into structured gameplay event data. The one or more computing devices 36 may be configured to understand how many cards have already been dealt and/or how many cards remain in the card shoe based on the data from the one or more detection devices. The one or more computing devices 36 may be configured to recognize one or more playing cards, gaming chips, and/or currency, so that it can perform a matching function by comparing the one or more items to a model stored in a database when the one more playing cards, gaming chips, and/or currency are observed on the gaming table. The computing device 36 may be configured to recognize or identify or correlate the data, images, and/or video to one or more players, casino staff, or both based on stored images and/or data stored in a database.

The one or more computing devices 36 and/or analysis devices 38 may be configured to transform the data received from the one or more detection devices 32, 34 into structured gameplay event data. For example, the computing devices may process sequential image frames to detect and classify gaming objects (e.g., cards, chips) and gameplay actions (e.g., wagers, card dealing, player decisions), and may generate a time-sequenced dataset of gameplay events associated with the gaming table. The structured gameplay event data may include time stamps, object identifiers, wager values, card values, and event types, which may be stored in memory and used for subsequent analysis.

The computing device 36 may be provided with machine learning and/or deep learning software or structure to learn and output card and/or chip values with a greater amount of confidence.

The computing device 36 may also be configured to recognize one or more trigger events. A trigger event may be or may correspond to a game play session, and more specifically to a start or a completion of a gameplay segment, time interval, or session.

The computing device 36 may be configured to recognize one or more first trigger events and one or more second trigger events. The one or more trigger events may take place on the gaming table, near a gaming table, and/or in one or more of the regions of interest on the gaming table. The one or more trigger events may be detected based on changes in the structured gameplay event data over time.

A first trigger event may be associated with a start of game play. A first trigger event may be or include one or more triggers or events such as: the gaming table being made available for game play by a dealer or other casino staff, one or more players arriving at the gaming table, a cover being removed from the chip tray, a dealer inserting cards into a card shoe, one or more bets being placed on the table, one or more cards being withdrawn from the card shoe, one or more playing cards being placed in front of one or more players, a dealer tapping in, a display or light being turned ON at the gaming table, at a certain time of the day, or any combination thereof.

A second trigger event may be associated with end of game play or a game play sessoin. A second trigger event may be or include one or more triggers or events such as: a dealer performing a payout to one or more winners, a dealer collecting gaming chips from one or more losing players, a player folding their hand, a dealer collecting one or more cards from the player area, identification of a cut card, an empty shoe, a full card discard rack or an empty discard rack, after a shuffle takes place, one or more players leaving the gaming table, a dealer closing the gaming table, a cover being placed on or over the chip tray, a dealer tapping out, a display or light being turned OFF at the gaming table, at a certain time of the day, or any combination thereof.

As discussed herein, the game monitoring device 100 and/or method 100 may be used to monitor, interpret, and/or analyze game play at one or more gaming tables.

The game monitoring device 100 and/or method 100 and/or a computing device 36, and/or an analysis device 38 may be configured to receive one or more data, signals, images or video feed(s) from one or more of the detection devices 32,34. The game monitoring device 100 and/or method 100 and/or a computing device 36, and/or an analysis device 38 may be configured to monitor, observe, and follow game play taking place in real time, at a slightly delayed time (e.g., a buffer of a few or predetermined amount of seconds or minutes) or after game play has ended, from the one or more images or video feed(s). The game monitoring device 100 and/or method 100 and/or a computing device 36, and/or an analysis device 38 may be configured to process the data to track gameplay activity in real time, in a buffered time window, or after completion of gameplay. A computing device, analysis device, or both may be a processor, computer, memory, hardware, software, etc.

The game monitoring device 100 and/or method 100 and/or a computing device 36, and/or an analysis device 38 may be configured to generate a time-sequenced dataset of gameplay events and to correlate wager behavior with computed gameplay advantage values. The game monitoring device 100 and/or method 100 and/or a computing device 36, and/or an analysis device 38 may be configured to compare game play at the table to one or more tables or input into one or more algorithms, software, machine learning models, deep learning models, or a combination thereof to determine if one or more players at the gaming table are utilizing techniques to gain an advantage over the house or casino, for example by counting cards. In this regard, the game monitoring device 100 and/or method 100 and/or a computing device 36, and/or an analysis device 38 may comprise or be provided with one or more computing devices, processors, memory, software, algorithms, tables, look-up tables, game rules, basic game play strategy, or a combination thereof. The game monitoring device 100 and/or method 100 may use or apply one or more of the aforementioned structures to the observed game play to determine if card counting, hole carding, or other advantage play is taking place.

The gameplay event data may be analyzed by the one or more processing devices to identify a pattern of player behavior indicative of advantage play. For example, the one or more processing devices may correlate wager amounts with computed gameplay advantage values over a sequence of hands. Additionally or alternatively, the one or more processing devices may analyze temporal changes in wager size, deviations from expected basic strategy decisions, entry or exit timing relative to gameplay conditions, frequency and timing of side wagers, player decision timing, or correlations between multiple players at the gaming table. In some configurations, the one or more processing devices may further evaluate whether player actions are consistent with predicted or observed card distributions, including tracking a running count of dealt cards and comparing player behavior to expected behavior under varying advantage conditions. The one or more processing devices may also identify coordinated behavior among multiple players, including signaling patterns, staggered betting strategies, or role-based activity indicative of team-based advantage play.

The game monitoring device 100 and/or method 100 may include or output information or an alert or an alert record to an alerting device 40 that is configured to provide an alert or alert record to casino staff or management that suspicious game play is taking place.

However, to protect the one or more players from the casino interfering with game play and to comply with many casino gaming commissions or jurisdictions, the alert or alert record is not provided until after game play has ended. The alert or alert record may be stored in a memory or queue or buffer and withheld from transmission until a trigger event corresponding to completion of gameplay is detected.

Delaying transmission in this manner allows additional gameplay data to be incorporated into the analysis and reduces the likelihood that ongoing gameplay behavior is influenced by the alert. The alert or the alert record may be at least temporarily stored in a memory or a memory structure until after the second trigger event is detected. For example, the alert or alert record may be stored in a buffer or queue until after the second trigger event is detected.

In some configurations, the alert generated by the analysis device 38 may be stored in a memory structure, such as a buffer, queue, or data record, rather than being immediately transmitted. The memory structure may maintain one or more alert records associated with a gameplay session, and each alert record may be updated, modified, or supplemented as additional gameplay event data is processed. The computing device 36 may control release of the alert from the memory structure based on detection of one or more trigger events, such that the alert remains inaccessible to external devices until predetermined conditions are satisfied.

Delaying transmission of the alert in this manner may allow the computing device 36 and/or analysis device 38 to incorporate additional gameplay event data into the analysis, thereby improving accuracy and confidence of the determination. In addition, withholding transmission of the alert during active gameplay may reduce the likelihood that ongoing gameplay behavior is altered in response to the alert, which could otherwise affect the integrity of the collected data. Accordingly, the delayed transmission provides a technical improvement in the operation of the system by controlling data flow and ensuring that analysis is based on a more complete dataset.

In some configurations, the alert record may be updated based on ongoing monitoring of gameplay activity. For example, as additional gameplay event data is received and processed, the one or more processing devices may modify the alert record to include newly detected gameplay events, updated wager information, and/or updated player behavior data. The alert record may store one or more parameters associated with the detected pattern of behavior, such as a confidence value, a running count of dealt cards, a correlation between wager amounts and computed gameplay advantage values, or a deviation from expected gameplay strategy.

In some embodiments, the alert may be delayed or prevented from being transferred to an external device or to casino personal to avoid interference with ongoing gameplay by casino personnel. For example, because certain forms of advantage play (e.g., card counting) are not inherently illegal, premature notification to casino operators could prompt immediate intervention that disrupts the game, alters player behavior, or otherwise affects the natural progression of gameplay. By delaying transmission of the alert until a suitable condition is met (e.g., completion of a hand, shoe, or gaming session), the system enables continued, uninterrupted observation of gameplay while preserving the integrity of the underlying data. This approach may further allow casino operators to take measured, policy-compliant actions at an appropriate time, rather than reacting in real time, thereby improving both operational consistency and the evidentiary value of the detected gameplay patterns.

The one or more processing devices may update the alert record over a sequence of hands or over a defined time window, and may adjust the confidence value or other parameters as additional gameplay events are processed. In some configurations, the alert record may be strengthened if the detected pattern of player behavior persists or becomes more pronounced over time. For example, the one or more processing devices may increase a confidence value when player wager amounts continue to correlate with favorable gameplay conditions, or when player decisions repeatedly deviate from expected strategy in a manner consistent with advantage play.

In other configurations, the alert record may be weakened or suppressed if subsequent gameplay activity does not support the detected pattern. For example, if later gameplay events indicate that player behavior is inconsistent with the previously identified pattern, the one or more processing devices may reduce the confidence value or remove the alert record from memory. The alert record may be stored in a memory or memory structure and updated until a trigger event corresponding to completion of gameplay is detected, at which point the alert record may be finalized and released.

In some configurations, the alert record may be transmitted from the one or more processing devices to an alerting device during gameplay, but the alerting device is configured to maintain the alert in a non-activated state until receipt of an additional signal indicative of a second trigger event corresponding to completion of a gameplay session. The alerting device may store the received alert record in a memory or memory structure or memory device, for example a buffer or queue, and may monitor for an additional signal, which may be generated by the one or more processing devices based on detection of the second trigger event from gameplay event data. Upon receipt of the additional signal, the alerting device may transition the alert from the non-activated state to an activated state and provide the alert via one or more output modalities. Prior to receipt of the additional signal, the alerting device prevents activation of the alert despite having received the alert record, thereby controlling timing of alert presentation based on the detected completion of gameplay.

The game monitoring device 100, computing device 36, analysis device 38, and/or alerting device 40 may comprise one or more servers, networks, processors, computers, memories, hard drives, RAM, software, algorithms, machine learning techniques, deep learning techniques, or a combination thereof for carrying out the method and/or steps disclosed 100 herein. The method 100 according to these teachings may make use of the system 100 and/or the one or more servers, networks, processors, computing devices, models, interpretation engines, machine learning, deep learning, and/or detection devices disclosed herein.

The one or more processors, analysis servers, computing devices, servers, and/or devices 36,38,40 may comprise one or more memories, processors, hard drives, RAM, CPUs, for storing information/data, for analysis and interpretation information/data, for executing or running one or more programs or interpretation engines, or a combination thereof. The one or more servers or devices 36,38,40 may include one or more software, algorithms, look-up tables, rules, deep learning models, machine learning models, or any combination thereof for running the method according to these teachings. The one or more servers or devices 36,38,40 may be programmed and/or reprogrammed with software, code, algorithms, look-up tables, basic strategy rules, statistical analyses, etc. to execute the method according to these teachings. The one or more servers or devices 36,38,40 may be updated over time as the one or more servers are provided with information from the one or more models and/or detection devices to continue to learn and improve efficiency and accuracy of the method. The one or more servers may be programmed or reprogrammed via or using artificial intelligence, machine learning, deep learning, or manual updates by software engineers.

The method disclosed herein may be used to monitor, understand, predict, review, analyze, decipher, and/or observe various operations and/or game play at one or more gaming tables at a casino.

The system 100 and/or method may include a machine learning and/or deep learning capabilities. For example, a machine and/or deep learning function might learn the relative dimensions and the patterns of a playing card or chip, when viewed from the top (e.g., via a detection device) as well as the card or chip from a side view (e.g., detection device at the gaming table). Such analysis can provide information to the casino that was previously recorded manually by casino staff or operators. The machine learning model and/or the deep learning model may be located on one or more of any of the one or more servers or networks disclosed herein, such as the cloud server, the premise server, table server, and/or the overhead detection server.

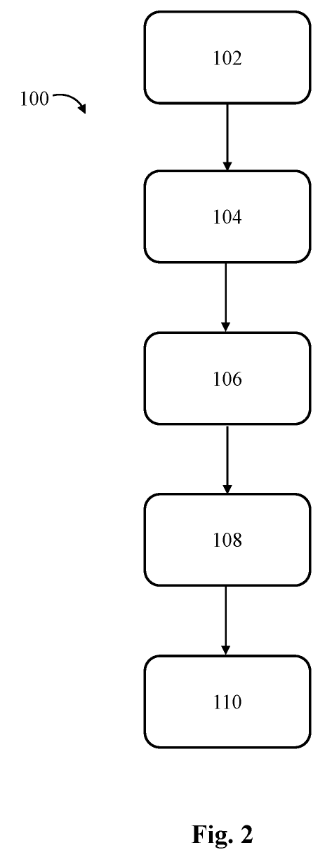

FIG. 2 is a block diagram that depicts steps of the method 100 described herein.

Referring to both FIGS. 1 and 2, the method 100 may include a step 102 of: receiving, by one or more processing devices or computing devices 36, data (e.g., image data, sensor data, etc.) a casino gaming table 10 that are obtained from or using one or more detection devices 32,34.

The image or sensor data may include timestamp information of a capture time of the one or more images. A timestamp may be provided onto the image or sensor data upon receipt by the one or more processing device or computing devices 36 from the one or more detecting devices 32,34.

In some configurations, the one or more detection devices 32,34 may be t image and/or video cameras. In other configurations, the one or more detection devices may be one or more RFID readers, smart chip readers, presence sensors or detectors, proximity sensors or detectors, or the like. For example, a detection device may sense absence of cards in the shoe by way of a proximity or weight sensor, and provide output data to a computing device that the shoe is empty. For example, a detection device may sense presence of cards in the discard rack by way of a proximity or weight sensor, and provide output data to a computing device that the discard rack is full. In these situations, the one or more detection devices 32,34 may output data to a computing device or processing device.

Responsive to receiving the image or sensor data, the method 100 includes a step 104 of: identifying or detecting, by the processing device or computing device 36, a first trigger event associated with game play at the casino gaming table 10. The first trigger event may correspond to initiation of a gameplay session at the casino gaming table. For example, the first trigger event may be or may include the gaming table being made available for game play by a dealer or other casino staff, one or more players arriving at the gaming table, a cover being removed from the chip tray, a dealer inserting cards into a card shoe, one or more bets being placed on the table, one or more cards being withdrawn from the card shoe, one or more playing cards being placed in front of one or more players, or any combination thereof.

During or after this step 104, or during another steps, the method may include a step of identifying or detecting, with the processing device or computing device 36, one or more regions of interest on the casino gaming table from the image or sensor data

Responsive to the identifying or detecting step 104, the method 100 includes a step 106 of: processing the image or sensor data to track gameplay activity or monitoring or tracking the game play at the casino gaming table 10 with the processing or computing device 36 by observing, monitoring, or tracking the image or sensor data or an image or video feed of activity taking place at the casino gaming table 10 obtained by the one or more video/image devices 32,34.

During or after the monitoring or tracking step 106, the method 100 includes a step of identifying, by the computing device 36, a second trigger event associated with game play at the casino gaming table 10. The second trigger event may correspond to the end of a gameplay session at the casino gaming table. For example, the second trigger event may be or may include a dealer performing a payout to one or more winners, a dealer collecting gaming chips from one or more losing players, a player folding their hand, a dealer collecting one or more cards from the player area, identification of a cut card, an empty shoe, after a shuffle takes place, a full card discount rack, one or more players leaving the gaming table, a dealer closing the gaming table, a cover being placed on or over the chip tray, or any combination thereof.

The one or more trigger events used to control transmission of the alert may be detected from the structured gameplay event data. For example, the computing device 36 may detect completion of a gameplay session based on identification of a sequence of events, such as detection of a cut card, a shuffle operation, or a threshold number of dealt cards. Upon detection of the trigger event corresponding to completion of the gameplay session, the computing device 36 may release the stored alert from memory and transmit the alert to one or more external devices.

After the first trigger event is identified and/or after the second trigger event is identified, the method 100 includes a step 108 of analyzing, with an analysis device 38, the game play at the casino gaming table 10. The analysis device 38 may comprise a deep learning model, an artificial intelligence model, a machine learning model, an artificial neural network, or a combination thereof. The analysis device 38 may take into consideration card value data; wager amounts, keep track of a running count of the cards dealt; and keep track of the number s of cards dealt or remaining in the shoe. The analysis device 38 may compare player wagering behavior to the running count; and then identify players whose wagering behavior deviates from expected behavior based on the running count, thereby indicating potential card counting, hole carding, or other advantage play by computing correlations between wager amounts and a running count derived from detected card values over a sequence of hands.

Accordingly, the analyzing step 108 comprises analyzing, by the one or more processors, the gameplay event data to identify one or more patterns of player behavior indicative of advantage play, anomalous behavior, or predefined behavioral conditions.

In some configurations, the analyzing step 108 may take place in real time after the first trigger event is detected. In other words, the analysis device 38 may analyze game play at the casino table and player behavior (strategy and betting) live during actual game play in real time or during near real time. The analysis device 38 may count cards and using statistics predict if the next hand is in favor of the dealer or player. If it is determined that the player is betting in accordance with the predicted advantage (e.g., increasing bets when the player has advantage and decreasing bets when the house has advantage), then the analysis device 38 may determine that the player is using card counting techniques, hole carding, or other advantage play. Of course, the analysis device 38 will continue to observe the player behavior to ensure the player is simply not winning based on luck. Accordingly, the analysis device also considers blackjack basic strategy rules. Such rules may be stored in a memory or look up table that is accessible to the analysis device.

In other configurations, the analyzing step 108 may take place after the second trigger event is detected. In other words, the analysis device 38 may analyze past game play at the casino table and player behavior (strategy and betting) that has already taken place.

Data from the analysis device 38 may be stored temporarily or permanently in a memory or log file. The data may be provided to a player rating system and used to build a profile of a player in case the player moves to another gaming table, another casino, or returns back another day. If a player continues playing at another table or casino, the analysis device 38 may continue to monitor and analyze the player’s behavior to determine with a greater degree of certainty if the player utilizes techniques to improve their odds or advantage over the casino.

In other configurations, the data can be input into a player rating system to determine the skill level for a player. In general, players at the table get rated on a theoretical (theo) associated with the exact rules of the game and a predetermined Theo. Using the analysis method proposed, the system will analyze values related to the exact advantage at any point, in conjunction with the wagering and play behavior, to determine the precise theoretical for each given hand. Such information can be used for player reinvestment.

Responsive to the analyzing step 108, the method 100 includes a step 110 of providing an alert with an alerting device 40, if suspicious player betting and/or playing behavior is identified at the gaming table 10 by the analysis device 38. The alert is delayed and not provided by the alerting device 40 until after the second trigger event is detected, which indicates an end of the game play at the casino gaming table 10. The alert may be maintained in a memory and released only upon detection of the second trigger event.

In other configuration, the alert may be provided to the alerting device, but the alerting device is not activated until after a predetermined amount of time has elapsed, until after the second trigger event is observed, after the game session has ended, or a combination thereof.

After the alerting device is activated, a casino dealer or staff may be made aware that potential advantage play has occurred. The dealer or casino staff can then take appropriate action, such as, for example, closing the table, raising the minimum bet, lowering the maximum bet, relocating the players to another table, etc.

The alert can be connected to casino staff, a pit boss, a supervisor, dealer or a combination thereof in one or more modalities, including, including visual indicators (e.g., lights or displayed messages), audible signals (e.g., tones or spoken messages), haptic feedback (e.g., vibrations), video outputs, or any combination thereof. The alert can be displayed on one or more table signs 22, an elevated table or tower sign 28, a keypad 30, and/or another device associated with the dealer, such as a wearable device (e.g., a watch, earpiece, or other portable electronic device).

The one or more computing devices, processing devices, analysis devices, etc. disclosed herein may comprise one or more devices configured to execute instructions to perform the functions described herein. The one or more computing devices, processing devices, analysis devices, etc. disclosed herein may include one or more processors, microprocessors, central processing units (CPUs), graphics processing units (GPUs), application-specific integrated circuits (ASICs), field-programmable gate arrays (FPGAs), or any combination thereof.

The one or more computing devices, processing devices, analysis devices, etc. disclosed herein may be in communication with one or more memory devices configured to store instructions, data, and/or models used to perform the methods described herein. The memory may include volatile memory, non-volatile memory, or a combination thereof, including random access memory (RAM), read-only memory (ROM), flash memory, or other computer-readable storage media.

The one or more computing devices, processing devices, analysis devices, etc. disclosed herein may be configured to execute one or more software modules, algorithms, or models to process data generated by the one or more detection devices. Such processing may include detecting gameplay events, identifying gaming objects, determining performance metrics, computing scores, generating feedback outputs, and updating dealer-related values as described herein.

The one or more processing devices 36 may be configured to transform image or sensor data into game play event data and performance metrics. Game play event data may comprise a sequence of time-stamped gameplay events detected from the image or sensor data.

In some embodiments, the one or more computing devices, processing devices, analysis devices, etc. disclosed herein may be located at or integrated with the gaming table 10, such as within a table housing, a table sign, a keypad, or another component of the gaming table 10. In such embodiments, the one or more computing devices, processing devices, analysis devices, etc. disclosed herein may comprise an edge computing device configured to process data locally at the gaming table 10.

In some embodiments, the one or more computing devices, processing devices, analysis devices, etc. disclosed herein may be located remote from the gaming table 10, such as within a surveillance room, server room, or cloud-based computing environment, and may be configured to receive data from the one or more detection devices via one or more communication networks.

In some embodiments, the one or more computing devices, processing devices, analysis devices, etc. disclosed herein may operate in a distributed manner, wherein a portion of the processing is performed locally at the gaming table 10 and a portion of the processing is performed at a remote location. For example, initial processing or event detection may be performed locally, while computation of performance metrics, scoring, or reward determination may be performed remotely.

In some embodiments, the one or more computing devices, processing devices, analysis devices, etc. disclosed herein may process data using one or more machine-learning or deep-learning models trained to detect gameplay events, gaming objects, and dealer or player actions from image or sensor data. The one or more computing devices, processing devices, analysis devices, etc. disclosed herein may further utilize rule-based logic, statistical models, or threshold-based decision processes in combination with the machine-learning or deep-learning models including analysis of temporal patterns and sequences of gameplay events over time.

In some embodiments, the one or more machine-learning or deep-learning models may include one or more convolutional neural networks (CNNs), object detection models, classification models, or sequence-based models configured to process time-sequenced image or sensor data. The models may receive image frames or video data as input and output one or more detected gameplay events, identified gaming objects, and/or classified dealer or player actions, optionally with associated confidence values. The outputs of the models may be used by the one or more computing devices, processing devices, analysis devices, etc. disclosed herein to determine the one or more performance metrics.

The one or more computing devices, processing devices, analysis devices, etc. disclosed herein may be configured to operate in real time or near real time, such that data received from the one or more detection devices is processed with sufficient speed to generate feedback during ongoing gameplay.

It is understood that the method steps disclosed herein can be performed in virtually any order and are not necessary to be in the order disclosed herein unless otherwise noted. One or more of the steps can be combined with one or more other steps; one or more steps can be omitted or eliminated; one or more steps can be repeated or duplicated; one or more steps can be split into two or more steps; one or more of the steps can be rearranged in a different order relative to other method steps; or any combination hereof.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A computer-implemented method for monitoring gameplay at a casino gaming table, comprising:
receiving, by one or more processors, data representing gameplay at the casino gaming table from one or more detection devices the data comprising at least one of image data or sensor data;
processing, by the one or more processors, the data to generate gameplay event data;
detecting, by the one or more processors and from the gameplay event data, a first trigger event corresponding to initiation of a gameplay session;
in response to detecting the first trigger event, tracking gameplay activity at the casino gaming table using the gameplay event data;
detecting, by the one or more processors and from the gameplay event data, a second trigger event corresponding to completion of the gameplay session;
analyzing, by the one or more processors, the gameplay event data to identify one or more patterns of player behavior indicative of advantage play, anomalous behavior, or predefined behavioral conditions;
generating, by the one or more processors, an alert, alert record, or output signal based on the identified one or more patterns of behavior and
at least temporarily storing the alert record in a memory structure and preventing access to, activation of, or transmission of the alert or alert record or the output signal to one or more external devices prior to detection of the second trigger; and
in response to detection of the second trigger event, enabling transmission or activation of the alert, alert record, or output signal to one or more external devices.

2. The method of claim 1, comprising identifying one or more regions of interest on the casino gaming table and extracting the gameplay event data from the one or more regions of interest.

3. The method of claim 1, wherein the first trigger event includes one or more of:
placement of a wager, initial dealing of one or more cards, or activation of the gaming table for gameplay.

4. The method of claim 1, wherein the second trigger event includes one or more of:
detection of a cut card, detection of a shuffle operation, detection of an empty card shoe, or collection of cards from the gaming table.

5. The method of claim 1, wherein the analyzing comprises applying one or more statistical models or machine learning models to the gameplay event data.

6. The method of claim 1, wherein the one or more detection devices comprise one or more cameras positioned at or above the gaming table.

7. The method of claim 1, wherein the analyzing is performed during the gameplay session and the alert record remains inaccessible until the detection of the second trigger event.

8. The method of claim 1, wherein analyzing is performed after the detection of the second trigger event.

9. The method of claim 1, wherein analyzing is performed before the detection of the second trigger event.

10. The method of claim 1, wherein the alert record is stored in a buffer or queue until after the second trigger event is detected.

11. The method of claim 1, wherein the alert record is transmitted to a display device at the gaming table, and/or is released to a wearable device by a dealer, supervisor, or surveillance personnel.

12. The method of claim 1, wherein the alert record is transmitted to a casino limit sign to change the maximum betting limit.

13. The method according to claim 1, wherein the one or more processors utilize a deep learning model, an artificial intelligence model, a machine learning model, an artificial neural network, or a combination thereof.

14. A system for monitoring gameplay at a casino gaming table, comprising:
one or more detection devices configured to capture data associated with the casino gaming table;
one or more processors in communication with the one or more detection devices; and
a memory in communication with the one or more processors, the memory storing instructions that, when executed by the one or more processors, cause the one or more processors to:
i) receive the data from the one or more detection devices;
ii) process the data to generate gameplay event data;
iii) detect, from the gameplay event data, a first trigger event corresponding to initiation of a gameplay session;
iv) track gameplay activity based on the gameplay event data;
v) detect, from the gameplay event data, a second trigger event corresponding to completion of the gameplay session;
vi) analyze the gameplay event data to identify one or more patterns of player behavior indicative of advantage play, anomalous behavior, or predefined behavioral conditions;
vii) generate an alert record or output signal based on the identified pattern;
viii) store the alert record in a memory structure and preventing access to, activation of, or transmission of the alert record or the output signal to one or more external devices prior to detection of the second trigger;

15. The system according to claim 14, wherein the one or more detection devices comprise one or more cameras positioned at or above the gaming table and/or one or more sensors on the gaming table.

16. The system according to claim 14, wherein the gameplay event data comprises a sequence of time-stamped gameplay events detected from the image data.

17. The system according to claim 14, wherein the alert record is stored in a memory device until after the second trigger event is detected.

18. The system according to claim 14, wherein the alert record is released to a display device at the gaming table.

19. The system according to claim 14, wherein the alert record is released to a wearable device by a dealer, supervisor, or surveillance personnel.

20. The system according to claim 14, wherein the first trigger event includes one or more of: placement of a wager, initial dealing of one or more cards, or activation of the gaming table for gameplay; and the second trigger event includes one or more of: detection of a cut card, detection of a shuffle operation, detection of an empty card shoe, or collection of cards from the gaming table.
